(19) United States
(12) Patent Application Publication
(10) Pub. No.: US 2017/0293290 A1
(43) Pub. Date: Oct. 12, 2017

(54) SYSTEM FOR DIGITALLY SUPPORTING A WORK PROCESS

(71) Applicant: LIEBHERR-WERK NENZING GMBH, Nenzing (AT)

(72) Inventors: Marcel FLIR, Feldkirchen (AT); Christian SCHNEIDER, Schlins (AT); Christoph MAI, Dornbirn (AT); Sebastian VALLASTER, Bartholomaeberg (AT)

(21) Appl. No.: 15/481,982

(22) Filed: Apr. 7, 2017

(30) Foreign Application Priority Data
Apr. 8, 2016 (DE) 10 2016 004 264.8

(51) Int. Cl. G05B 19/418

(52) U.S. Cl. CPC G05B 19/41865; G05B 2219/31053

(57) ABSTRACT

The present disclosure relates to a system for digital support of a work process including: a database for accepting different data and data types; a means for planning a work process that has access to the database and is configured to store a work plan in the database; a means for analyzing the work plan that carries out an analysis using the present data of the database to carry out an optimization of the work plan; a means for simulating the work plan that has access to the database and that is configured to output data for simulating the work plan; and a means for navigation support and control support of a machine that has access to the database and that is configured to communicate specific data of the work plan from the database to an associated machine during and/or before the real implementation of the work plan.

### CROSS REFERENCE TO RELATED APPLICATIONS

This application claims priority to German Patent Application No. 10 2016 004 264.8, entitled “System for Digitally Supporting a Work Process,” filed Apr. 8, 2016, the entire contents of which are hereby incorporated by reference for all purposes.

### TECHNICAL FIELD

The present disclosure relates to a system for digitally supporting a work process as well as to a corresponding method for its performance. The system supports cranes and construction machinery. The machine may be a construction machine or a crane and, in one example, a crawler-mounted crane, a hydraulic cable excavator, a pile driver or a drilling rig, an offshore crane, a ship crane and/or a harbor mobile crane.

### BACKGROUND AND SUMMARY

A work process in larger projects is conventionally subjected to a complex planning process. First, a georeferenced 3D terrain model is prepared that maps the terrain on which the work process is to be carried out. Starting from this information, a work plan is prepared and passed on to partners and employees of other trades. They make their plans on the basis of the documents passed on to them.

It is problematic with this procedure that changes are not definitely passed on to the planners and changes resulting therefrom are not necessarily taken up into the work plan.

Changes could easily be lost by procedures typical in the prior art. It is thus possible, for example, that a lifting operation using a plurality of cranes only exists as a paper document and all machine operators are given verbal instructions. During the lifting operation, the operators are individually verbally instructed about the respective required driving movements of the individual crane. The operator only carries out individual instructions without knowing the underlying work plan in detail. It can also occur that the part work plans originating from different trades are not ideally coordinated with one another.

As can be seen for the example of a crane, it can therefore occur that with an imprecise assumption of conditions, the planning of the lifting operation, in particular of the parameters of payload, mass, center of gravity or geometrical dimensions, has to be carried out again. In addition, the processes have no continuous documentation and an analysis of the weak points is not possible in retrospect.

The present disclosure overcomes the disadvantages arising from the prior art in that it enables a direct transition of the work plan free of media disruptions from the means of the planning into the means of the simulation or into the means of the navigation support and control support. The disadvantages of the prior art are overcome by the present disclosure. It is possible to pass on a work plan to another planner such that the work plan is either locked for the preparer or such that the work plan is edited in a cooperative mode together by both sides. After the final editing of the work plan, it is communicated to the individual operators of machinery and/or to the coordinators of the work process.

As one embodiment, a system for digitally supporting a work process comprises a database for receiving different data and data types; a means for planning a work process that has access to the database and is configured to store a work plan in the database, with the work plan, in one embodiment, comprising the configuration of a machine (including tools such as hooks or special underground engineering tools); a description of the working environment, including an optional load as well as a plurality of worksteps; and a means for simulating the work plan that has access to the database and that is configured to output data for simulating the work plan and a means for navigation support and control support of a machine that has access to the database and that is configured to communicate specific data of the work plan from the database to an associated machine during and/or before the real implementation of the work plan, as well as means for analyzing the work plan that carries out an analysis using the present data of the database to carry out an optimization, in particular of the work plan, of the machine or of the driving behavior of the operator.

In this respect, the database is a storage location present locally or in a cloud for storing and polling data. It is thereby possible that every party involved in the work process has access to the latest work plan. Provision can in particular be made that the terrain on which the work process is to be implemented is provided to the database in a digital manner.

The means for planning a work process serves the preparation of a work plan that comprises the respective machine or machines (in the specific configuration), the environment (based on a georeferenced 3D model) and an optional load as well as the individual worksteps of the machine. The matching machine in the matching configuration is typically searched for or is directly selected by an experienced user in the planning, that is in the preparation of a work plan, for a specific task, such as a lifting operation. The available machines are stored in the database in this respect.

The system is configured in this respect such that depending on the user group (lessee, lessor, scheduler, planner), the different demands with respect to access, interface and function are prepared for the respective user group so that the respective information can be transmitted in dependence on the objective and kind of application. The main focus of a scheduler is thus much rather on faster and easier access to all the machines and all the available configurations of a vehicle fleet, whereas what is important for the planner is the import of 3D drawings and the ability to present the relevant parameters such as bearing load, payload, distance from the environment, etc. for all the individual steps such as a workstep or a lift, for example. In addition, the means for planning a work process can be configured such that an individual workstep such as a lift can be divided into a plurality of worksteps. A lifting operation can thus comprise information on the crane configuration, the environment, the load and the respective worksteps and can be stored in the database such that a later, more closely described simulation can access these data. The operation of one machine or of a plurality of machines can be planned using the means of the planning.

The means for simulating the work plan has access to the database such that a simulation can be carried out using the work plan or the steps of the work plan stored in the database. The means for simulation is accordingly configured to forward data, in particular the generated work plan, to a simulator or to generate a simulation environment itself and to output it to simulate individual worksteps or the entire work plan. It is possible that in this respect specific instructions are sent to the simulator for every workstep such that the operator of the simulator or the trainers of the simulation process have their attention drawn to a non-ideal design of a work plan (work plan or workstep) and such that thereupon a new, optimized routine is defined having its own worksteps or a changed configuration that is then stored in the database.

Non-ideally planned work plans and worksteps can already be recognized before the real execution and can be optimized in a very early stage with this procedure. The basis for this is, however, that both the means for simulation and the means for planning access a common database in which the data of the work plan are stored. It is of advantage if the data of a georeferenced 3D terrain model likewise form the basis of the work plan. The reliability of the data is particularly high since no problems in the manual conversion or in the up-to-dateness of the currently used information are hereby present and since the use of a common platform is possible without any media disruption.

The system furthermore has a means for analyzing the work plan in comparison with the received process data that carries out an analysis with reference to the existing data of the database to decide whether an optimization of the work plan stored in the database or an optimization of the machine by repair and/or maintenance or an optimization of the behavior of the operator of the system is proposed.

The acquired process data can, one example, be compared with the work plan to recognize a deviation from the work plan or to obtain indications of a reduced power of the machine.

Statements on the quality of the operator of the machine, of the work plan and of the machine can be given by the comparison of process data. The system can propose specific action recommendations on the basis of these statements.

In the event that the operator does not operate the machines ideally, the system could store a training task in the database optimized to the specific manner of driving of the operator that is then invoked on the start of a simulation of the respective operator.

If the reduced power is due to a defect of the machine, this circumstance can be stored in the database so that the system sends a communication to a corresponding mechanic.

In the case of a non-ideally planned work plan, the system prepares a specific proposal for an optimization of the work plan. The planner can make a decision during the planning of the work process or during a revision of an already planned work plan on whether the originally planned workstep is to be maintained or whether the optimizing option proposed by the system should be applied.

A work process is digitally supported by the system having the features described herein so that fewer errors or unforeseen events occur and the work process can thus be carried out more efficiently and more effectively.

With a system in accordance with the present disclosure, all the process participants have the same level of information and the work plan and the underlying data are always up to date. All the information is synchronized via the common database. The data exchange takes place without any media disruption.

A further means of the system serves for the navigation and control support of a machine in the real implementation of the work plan. In this respect, a work plan is uploaded into the machine before and/or during operation that supports the operator in navigating a machine.

If, for example, georeferenced 3D data are stored in the work plan, the exact position of a workstep to be performed can be determined and a navigation aid on this point can be offered to the operator. For the example of a crane this would mean that the planned slew angle of the superstructure and of the undercarriage or the luffing angle of the main boom and of the luffing boom or the required height of the hook is displayed to the machine operator. The system can furthermore display further additional planning information that allows the operator a better overview and a better processing of a workstep of the work plan. The weight of a load to be lifted and/or the sheeving of the hook ideal for this purpose to lift the load is/are displayed, for example.

The system furthermore comprises a means for receiving process data of the machine on the execution of the work plan that has access to the database and that is configured to receive process data of a machine.

The system furthermore, in one embodiment, comprises a means for the output of information for the operation coordinator. The means for the output of operation can be a tablet, for example. It has access to the database and is configured to provide relevant information via a work machine and to determine a deviation of a step from the work plan by a comparison of planning data with current data. The system is configured to access process/state/control parameters of a machine used for the real implementation of the work plan and to compare them with the work plan stored in the database. The system can furthermore be used to navigate the machine operator through the work plan of the machine and to display additional information to the machine operator.

The means for the output of information is typically designed as a mobile device and transmits the relevant information from the machine and from the database via a communication module (e.g. wireless LAN/GSM). In this respect, the work plan can be compared with the current data so that a coordinator recognizes deviations at an early time and can provide corresponding counter-measures. A tandem stroke/multiple stroke can be named as an example in this respect in which the work of a coordinator is decisively simplified while making use of the information provided by the means for the output of information. It is additionally conceivable that information on the setup, operation and maintenance of a machine is provided via this means.

In accordance with a further development of the present disclosure, the system is configured to generate all the information for the respective means on the basis of a common database and to enter all the information generated herefrom into the common database to avoid divergences in the database used for generating the information.

The work plan, in one embodiment, comprises a sequence of a plurality of worksteps that contribute in their totality to the completion of the planned work process. In this respect, a plurality of machines can be assigned to one work plan that are suitable for carrying out the respective workstep.

In accordance with a further modification of the present disclosure, a workstep furthermore comprises the position for carrying out the workstep on the terrain of the work process and/or further parameters that relate to the step that in particular include a bearing load, a payload, a distance from the environment as the parameters.

The means for simulating the work plan is, in one embodiment, associated with a simulator that simulates a machine to simulate and subsequently to optimize the worksteps provided in the work plan with the aid of the simulator. It is of advantage in this respect to recognize problems occurring in the simulation and to adapt the work plan accordingly. It is of advantage when the simulator simulates the machine provided for carrying out the work plan in the respective configuration. The simulator can in this respect simulate the machine suitable for the workstep and has the same control as the simulated machine as well as the same operating units (such as a joystick, a keyboard, a monitor). Through the interaction with an operator, said operator is already prepared for critical work in advance in the simulation and can locate improvements to the work plan through his experience that should then, in one embodiment, be introduced via the means of the planning.

The information of the means for navigation and control support are supplied to the device operator directly via a display unit in the operator's cabin. In one embodiment, this may be done by way of an “augmented reality” representation in which the real environment is shown together with additional information on a display unit.

It is also advantageous in this connection if the means for receiving process data of a machine is configured to detect parameters on the actual use of the machine and to store them in the database during the carrying out of a workstep of the work plan by a machine. This allows the analysis between the desired value and the actual value of the step in the construction plan.

In accordance with a further development of the present disclosure, the means for the analysis is configured to design an optimization of future worksteps of a work plan more efficiently using the existing data of the database.

### BRIEF DESCRIPTION OF THE FIGURES

Individual embodiments of the present disclosure will be looked at in detail in the following with the help of the Figures.

FIG. 1 shows an overview of the functions of the system in accordance with the present disclosure for the digital support of a work process.

FIG. 2 shows an illustration for explaining a specific operation scenario of the present disclosure in more detail.

FIG. 3 shows an example of the system in accordance with the present disclosure for the digital support of a work process of a machine, such as a crane.

FIG. 4 shows a flow chart of a method for creating a work process for a system including a machine, in accordance with the present disclosure.

### DETAILED DESCRIPTION OF THE FIGURES

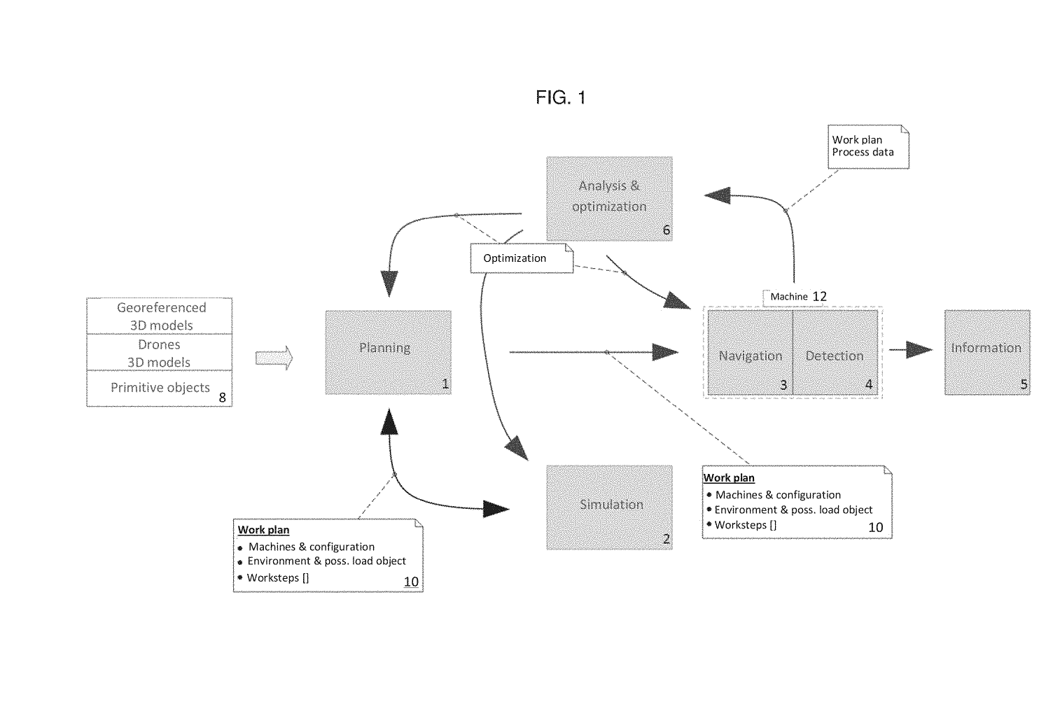

FIG. 1 shows the system with its plurality of means. The first means 1 for planning a work process can be recognized. It is thus possible to input data with the aid of drones to a georeferenced three-dimensional model to store digital surveying data of the terrain on which the work process is to be carried out. These digital data 8 serve as the basis or the planning of the work process.

After completion of the planning, a simulation of the work plan can be carried out with the aid of the means 2 for simulation. In this respect, the three dimensional model of the environment and the worksteps to be simulated, including the relevant parameters such as the position and angle of the machine, the payload, bearing load, etc., are passed on to the means for simulation 2 by the means for planning 1. This takes place via a storing of data in the database 10.

The means 3 serves for the navigation and control support of a machine 12 in the real implementation of the work process. In this respect, the work plans, in one embodiment, already simulated in a simulation are therefore carried out in reality. To support an operator of a machine, the means 3 is configured to have the support data, in particular drive assistance data, displayed to the operator. The location at which the next workstep of the machine is to be carried out or which control function is to be carried out next can thus be displayed to the operator of the machine, for example. The direction of the machine to be controlled, information on the next workstep and/or further helpful information can also be displayed.

This can very specifically mean, for example, that which luffing angle the main boom has to adopt to carry out the next workstep in the work plan is displayed to a machine operator. The control support information is naturally not restricted to a crane or to the slewing of a main boom, but can rather comprise all the relevant control actions of a machine.

To have the information on the navigation support and control support supplied to the machine, substantially similar data are passed on to the means 2 for simulation. Instead of a simulation by an associated simulator, the real implementation of the worksteps of a work plan in contrast takes place by an operator or by the machine operated by the operator.

The means 4 for detecting state parameters and control parameters of a machine is configured to receive a plurality of process data of the machine on a carrying out of a workstep of the work plan.

This would mean with respect to the previously introduced example of a crane as the machine that the means 4 for process data detection communicates all the state parameters of a crane such as the slewing angle of the superstructure, the luffing angle of the main boom and/or of the luffing boom, the position of the hook and the like to the means 6 for analysis so that the system can carry out a previously described analysis.

After carrying out this analysis, the conclusions drawn therefrom are forwarded to the means 1 for planning to correct possibly incorrectly planned steps in the work plan.

There is furthermore means 5 for the output of information that provides relevant information on a machine and makes a deviation of a workstep from the work plan recognizable by a comparison of planning data with current data. This means can be implemented by a tablet. It is therefore possible for a coordinator who monitors the correct implementation of the work plan to immediately recognize and counteract possible deviations from the desired state in a particularly simple manner.

After a complete preparation of the work plan it can be exported in the form of a protocol by the means of the planning.

The results of the simulation or of the analysis that takes place after the carrying out of a step can again be input into the database or into the individual worksteps of the work plan. The machine configuration can be optimized in this respect or an ideal distance, an ideal payload capacity and/or an ideal bearing load can be achieved. It is advantageous that the planning reaches the operator 1:1, that the plan can be simulated and that coordination on the work plan can be provided for all those involved by means of visualization.

It is clear to the skilled person that the disadvantages known from the prior art are overcome with the aid of the system in accordance with the present disclosure for the digital support of a work process.

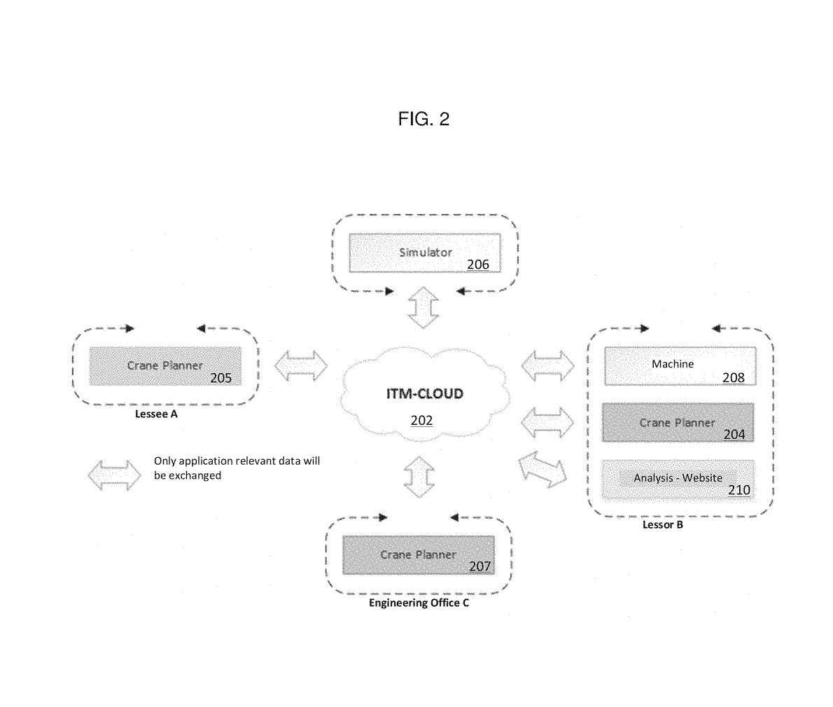

An exemplary scenario to illustrate the present disclosure will be shown in the following with reference to FIG. 2.

The cloud 202, or the database, is used as the central data store and point of exchange between the different means. It organizes the data distribution and data updating or the access and exchange of data and projects. Projects can be exchanged (sequentially > that is, project utilization after one another or cooperatively during simultaneous work on the project) between different partners.

The potential client works with a version of the planning tool (means for planning, called “Crane planner”, e.g., crane planners 204, 205, and 207 shown in FIG. 2) and in this respect, for example, defines its lifting task (40 t to 35 m height with a 16 m radius). It stores the project in the database 202 and releases it to the potential client, lessor B. Lessor B opens the project and enters the planning or the project in detail. Lessor B furthermore prepares an animation and a first project for lessee A. The lessee A is convinced and awards the lifting contract to the lessor B.

Lessor B would like to safeguard himself and to discuss the project again with an external engineering office C. Lessor B starts a “cooperative project mode” and invites engineering office C to take part. Both lessor B and engineering office C thus see the project and all the changes simultaneously. Both can make changes to the project. If lessor B wants to prepare his machine operator for the complicated lifting task, the revised project is sent to the next closest simulator 206 for this purpose.

It is thus possible that the operator tests the planned project and notices that he cannot agree to the planning. In one embodiment, his desired changes are then worked into the project by the lessor B.

The lessor B presents the project with the aid of a tablet or of another mobile device to the operator and to the remaining participants directly on the construction site. As soon as the machine 208 is dispatched for the operation, the project is transferred to the machine 208. The operator starts the machine and receives a workstep list (including erection/assembly) that he has to carry out.

The lift of an object weighing 40 t is provided in the plan. The operator notices while hitching the load on the construction site that it is 42 t heavy. It is possible by the use of the present disclosure that he consults with the planner. The latter updates the mass of the load object to 42 t and checks the dependencies of this adaptation. He transmits the updated project to the machine 208 again. The machine 208 displays the DESIRED 42 t and the ACTUAL 42 t to the operator. It is thereby ensured that the further lifting takes place without problem.

It is subsequently possible to analyze the lift. As explained above, the results of the analysis 210 that takes place after the carrying out of a step can again be input into the database 202 or into the individual worksteps of the work plan. It can be recognized in this respect that the operator did not follow the plan and had an operating problem, for example, too jerky a lift of the load, oscillating movements. It is possible to present a training adapted to the operating problem and to send the operator to the simulator 206 again.

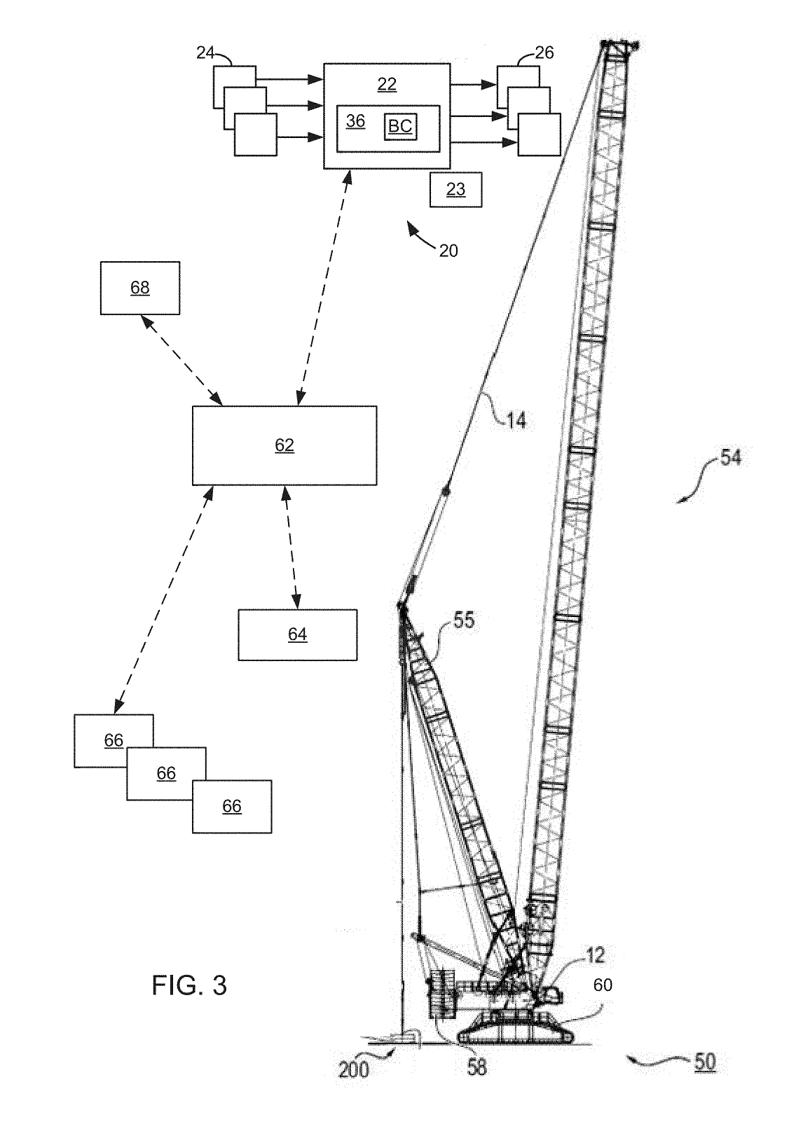

FIG. 3 shows an example of the system shown in FIG. 1. As shown in FIG. 3, the machine is a crane 50. The crane 50 has an undercarriage 60, the undercarriage 60 having a chassis which is designed as a crawler chassis in the drawn embodiment and comprises two crawler tracks arranged at the left and the right. A superstructure 12 rotatably supported about an upright, vertical axis of rotation is arranged on the undercarriage 60. The superstructure 12 carries a main boom 54 which is called a boom system within the framework of the present disclosure and can thus comprise all customary configurations of booms. This boom 54 is connected in an articulated manner to the superstructure 12 about a horizontal luffing axis and has a hoist rope, not shown, in a customary manner.

At the rear side of the superstructure 12 opposite the articulated connection point of the boom 54, the former carries an operating/superstructure ballast 58 which counteracts the tilting torque induced by the boom 54 or by a load suspended thereon.

The rearwardly directed derrick boom 55 is mounted behind the boom system 54, with the boom system 54 or the main boom head being guyed in a conventional manner via the adjustable guying 14 at the derrick boom 55.

It is necessary on the raising of very heavy loads to guy the derrick boom 55 via an additional derrick ballast. As a rule, a derrick ballast is used for this purpose which is suspended above the ground and which is here shown as a constant ballast 200 (alternatively referred to herein as a counter-weight arrangement 200).

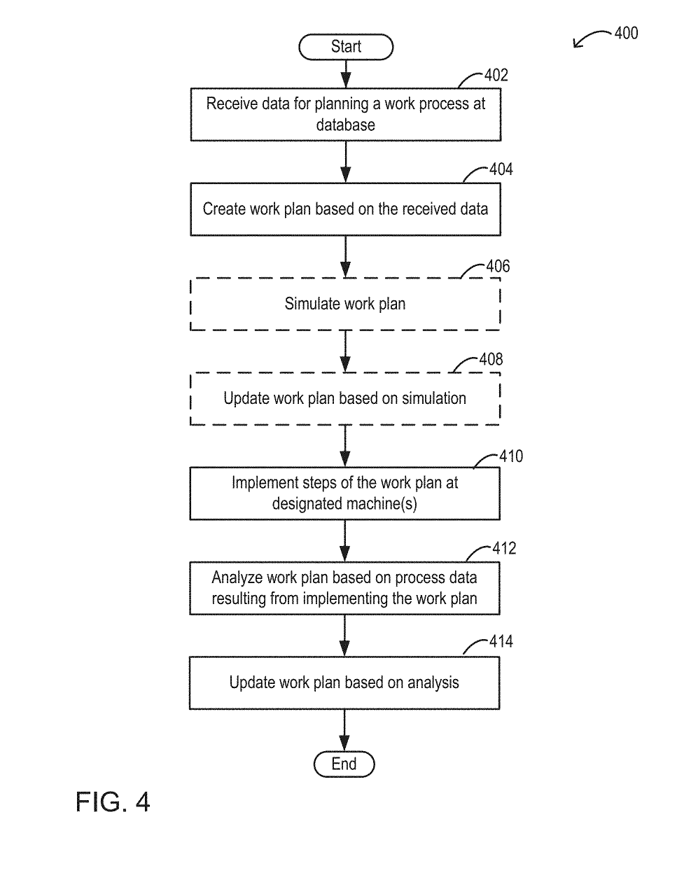

Crane 50 further includes a crane control system 20, which is schematically shown in FIG. 3. Crane control system 20 includes a control unit 22, sensors 24, and actuators 26. Control unit 22 includes a processor 34 and non-transitory memory 36, the non-transitory memory having instructions stored therein for carrying out the various control actions described herein, including control actions associated with the method shown in FIG. 4. The sensors 24 represent the various sensors and/or detection devices described herein. Sensors 24 further may include devices (e.g., display devices, joysticks, etc.) which receive input from an operator of the crane and send signals to the control unit responsive to the operator input. Control unit 22 receives signals from the various sensors 24 and employs the various actuators 26 to adjust operation of the crane (and optionally, of associated components such as the auxiliary crane), based on the received signals and the instructions stored in the non-transitory memory 36. The control system 20 may further include a display screen 23 which may display the work steps of the work plan, as described herein.

The system shown in FIG. 3 further includes a database 62, as described herein, that is in electronic (e.g., wireless) communication with the control system 20 and one or more additional devices or systems. For example, the system may further include a simulator 64, one or more planning devices 66, and one or more mobile devices 68 (such as a tablet, as described herein) that are each in electronic communication with the database 62. As such, information, such as the work plan described above, may be shared between the database 62 and the devices in communication with the database 62 (as shown by the dashed lines with double-headed arrows in FIG. 3). The one or more planning devices 66 may include a workstation, such as a computing device including a processor and memory (e.g., non-transitory memory), that is located remote from the crane 50. For example, each user group, such as the lessee, lessor, scheduler, and planner, as described above, may include a separate planning device 66 for reviewing, updating, and inputting data into the work plan (e.g., planning, as described above). As one example, each planning device 66 may include one or more input devices (such as a keyboard, touch screen, or mouse) for receiving input data for creating (e.g., planning) a work plan, the work plan including a plurality of steps. Further, each planning device 66 may include instructions stored in memory for analyzing the work plan, as executed by the machine (e.g., crane 50) and for optimizing the work plan stored in the database. In one example, as introduced above, the work plan may be transmitted between the database and the different planning devices 66 and between the database 62 and the control system 20 of the crane 50. Further, process data from execution of the work plan, via the actuators of the control system 20 of the crane 50, may be transmitted from the control system 20 to the database 62 and then may be analyzed via one or more of the planning devices 66 or an alternate device in communication with the database 62, such as the mobile device 68 and/or simulator 64.

Turning to FIG. 4, a flow chart is shown for a method 400 for creating a work process for a system including a machine, such as one or more of the systems described above with reference to FIGS. 1-3. Instructions for carrying out method 400 may be stored within a database (such as database 63 shown in FIG. 3) and/or one or more devices or control systems of the system (such as planning devices 66 and/or control system 20 shown in FIG. 3).

At 402, the method includes receiving data for planning a work process at a database. As described herein, the data may include a terrain on which the work process is to be carried out, one or more features or positions of the machine intended to carry out the work process, and/or tasks to be implemented by the machine. At 404, the method includes, creating a work plan based on the received data. The work plan may be created at one or more planning devices and/or at the database and then stored within the database. Additionally, the work plan may include one or more of a configuration of the machine, a description of a work environment of the machine, and a plurality of steps. At 406, the method optionally includes simulating the work plan via a simulator (such as the simulators described above) in communication with the database. Then, at 408, the method may optionally include updating the work plan stored at the database based on results of the simulation at 406.

At 410, the method includes implementing the created work plan at a designated machine or machines (e.g., such as crane 50 shown in FIG. 3). As one example, instructions for implementing the work plan at the designated machine may be stored in non-transitory memory of a control system, such as non-transitory memory 36 of control system 20 shown in FIG. 3. Further, the method at 410 may be executed by a processor of the control system (e.g., processor 22 of control system 20 shown in FIG. 3). For example, the control system may be in communication with one or more actuators (e.g., actuators 26), which may each be coupled to various movable components of the crane, in order to carry out the steps of the work plan. In some examples, the method at 410 includes displaying the steps of the work plan via a display device (e.g., display screen) of the machine to an operator of the machine.

At 412, the method includes analyzing the work plan based on process data resulting from (e.g., generated as a result of) implementing the created work plan at the machine. For example, the control system of the machine may create process data from various sensors of the control system, during execution of the work plan, and then send the process data to the database where it may be analyzed there or at one or more of the planning devices (or an alternate computing device in communication with the database). The method at 414 includes updating the work plan stored at the database based on the analysis at 412. The updated work plan may then be stored at the database and used for future implementations of the work plan at one or more machines.

1. A system, comprising:
a database;
one or more planning devices in communication with and adapted to share information, including a work plan, with the database, the one or more planning devices including one or more input devices for receiving data for creating the work plan, the work plan including a plurality of steps;
a machine including a control system in communication with the database and adapted to carry out the plurality of steps of the work plan.

2. The system of claim 1, wherein the one or more planning devices includes instructions stored in memory for analyzing the work plan, as carried out by the machine, and using existing data of the database to carry out an optimization of the work plan stored in the database.

3. The system of claim 1, further comprising a mobile device in communication with the database, the mobile device adapted to provide relevant information on the machine and to reproduce a deviation from the work plan by a comparison of planning data stored at the database with current data received from the control system of the machine.

4. The system of claim 1, further comprising a simulator in communication with the database and that is adapted to output data for simulating the work plan.

5. The system of claim 1, wherein the machine further includes a display screen for displaying the plurality of steps of the work plan to an operator of the machine.

6. The system of claim 1, wherein the machine is a crane.

7. A method for supporting a work process, comprising:
receiving data for planning a work process at a database;
creating a work plan based on the received data;
implementing the created work plan at a designated machine;
analyzing the work plan based on process data resulting from implementing the created work plan; and
updating the work plan stored at the database based on the analysis.

8. The method of claim 7, wherein the work plan includes one or more of a configuration of the machine, a description of a work environment of the machine, and a plurality of steps.

9. The method of claim 7, further comprising simulating the work plan via a simulator in communication with the database.

10. The method of claim 9, further comprising updating the work plan stored at the database based on results of the simulation.

11. A system for digitally supporting a work process comprising:
a database for receiving different data and data types;
a means for planning a work process that has access to the database and is configured to store a work plan in the database;
a means for the analysis of the work plan that carries out an analysis using the existing data of the database to carry out an optimization of the work plan stored in the database;
a means for simulating the work plan that has access to the database and that is configured to output data for simulating the work plan; and
a means for navigation support and control support of a machine that has access to the database and is configured to communicate specific data of the work plan from the database to an associated machine during and/or before the real implementation of the work plan.

12. The system in accordance with claim 1, wherein the work plan comprises the configuration of the machine, a description of a work environment, and a plurality of steps and wherein the optimization of the work plan stored in the database includes an optimization of individual steps of the work plan.

13. The system in accordance with claim 1, wherein the means for navigation support and control support of the machine is furthermore configured to accept process/state/control parameters of a machine used for the real implementation of the work plan and to compare them with the work plan stored in the database to navigate a machine operator through the work process of the machine and to display additional information to the machine operator.

14. The system in accordance with claim 1, furthermore comprising a means for the output of information that has access to the database and is configured to provide relevant information on the work process or on a machine used to implement the work plan and to reproduce a deviation from the work plan by a comparison of planning data with current data.

15. The system in accordance with claim 1, wherein the system is configured to generate all the information for the associated means on the basis of a common database to avoid deviations in the database provided to the means and wherein the work plan comprises a sequence of a plurality of steps for a machine that is suitable for carrying out the step.

16. The system in accordance with claim 1, wherein the work plan furthermore comprises one or more of the position of a machine for carrying out a step on the terrain of the work process and further parameters of the machine related to the step, wherein at least one of the further parameters related to the step is a lifting operation that includes a bearing load, a payload, and a distance from the environment as the parameter and wherein the machine to be used to implement the work plan is one or more of a crawler-mounted crane, a hydraulic cable excavator, a pile driver or a drilling rig, an offshore crane, a ship crane and a harbor mobile crane.

17. The system in accordance with claim 1, wherein the means for simulating the work plan is connectable or connected to a simulator that simulates a machine used for working through the work process to carry out the steps provided in the work plan with the aid of the simulator, wherein problems occurring in the simulation have the consequence of an adaptation of the steps carried out in the work plan.

18. The system in accordance with claim 1, wherein the means for navigation and control support communicates the individual steps of the work plan to the associated machine during the real implementation of the work plan, wherein the means for navigation and control support communicates one or more of the exact position or a travel path of the associated machine, the exact activity that is to be carried out by the machine, and additional information on the step to an operator of the machine.

19. The system in accordance with claim 1, wherein, if indications of a reduced power of the machine are recognized, the system is configured to output an error message that has the consequence of a repair of the machine or an indication of an improper use of the machine by the operator.

20. The system in accordance with claim 1, wherein the means for the analysis carries out an optimization of steps of the work plan using the existing data of the database to optimize one or more of a machine position, a machine movement, a travel speed of the machine and the configuration of the machine, wherein the optimized steps are stored in the database and wherein the database is a cloud-based database.
